(19) United States
(12) Patent Application Publication
(10) Pub. No.: US 2019/0337584 A1
(43) Pub. Date: Nov. 7, 2019

(54) SHOCK ABSORBER FOR A BICYCLE

(71) Applicant: DT SWISS INC., Grand Junction, CO (US)

(72) Inventors: Martin WALTHERT, Aarberg (CH); Karsten RICHTER, Biel (CH); Samuel ZBINDEN, Biel (CH)

(21) Appl. No.: 16/401,268

(22) Filed: May 2, 2019

(30) Foreign Application Priority Data
May 2, 2018 (DE) 102018110490.1

(51) Int. Cl. B62K 25/28; F16F 9/53; F16F 9/342; F16F 9/50; F16F 9/348; B62K 25/30; F16F 9/19

(52) U.S. Cl. CPC B62K 25/286; F16F 9/535; F16F 9/342; B62K 2025/044; F16F 9/3488; B62K 25/30; F16F 9/19; F16F 9/50

(57) ABSTRACT

A shock absorber for a bicycle including a damping system, the damping system including a damping chamber partitioned in a first chamber and a second chamber by a movable piston, a low-speed throttle for the low-speed range, and a high-speed throttle for the high-speed range, the high-speed throttle having a throttle valve biased to a closed position by a spring device. An effective flow cross-section for the high-speed throttle is adjustable.

### BACKGROUND

The present invention relates to a shock absorber for an at least partially muscle-powered, two-wheeled vehicle and, in particular a bicycle having at least one damping system. Such a shock absorber cannot only be employed in conventional two-wheeled vehicles and bicycles, but also in bicycles which are at least partially supported for example by an electric motor. Particularly preferably the invention is used for sports bicycles.

In the prior art, high-end spring damper components for the front wheel and the rear wheel have been disclosed wherein at least two different flow ducts tend to be provided for the direction of compression and the direction of rebound. This is for one, the so-called low-speed duct and for another, the high-speed duct for low-speed damping and for high-speed damping. The low-speed duct and the high-speed duct provide the major portion of the flow cross-section in normal operation. This means that both slow and fast movements have the damping fluid flow through said ducts.

In simple cases, the low-speed duct is a simple bore and the high-speed duct is for example blocked by a shim or a spring leaf which forms a one-way valve and will clear the duct and allow flow only above a specific opening pressure. This leads to a typical damping curve showing a parabolic outline in the low-speed range. This is followed by a break in the transition between the low-speed range and the high-speed range. Thereafter, the curve shows a flat shape after the high-speed duct has opened.

The more complex shock absorbers currently available in the market possess adjustable low-speed damping and/or high-speed damping in the compression and/or rebound directions. Adjustment outside of the damper may be possible via external operating members. Alternately, adjustment is possible only in the damper interior by way of demounting.

Adjustment of the low-speed damping is typically achieved by changing the flow cross-section of the bore. This adjustment causes different gradients in the low-speed range.

If external adjustment of the high-speed damping is also possible, this is realized by way of a variable bias of the shim or spring assembly or cover member above the high-speed duct. This leads to the requirement of a variable opening pressure until passage through the high-speed duct is enabled. The consequence is that the break point shifts while the curves are substantially parallel.

It is therefore the object of the present invention to provide a shock absorber which provides better adjustment options in the high-speed range. In particular, an adjustment of the damping in the high-speed range should not cause any shifting of the break point in the transition from the low-speed range to the high-speed range.

### SUMMARY

A shock absorber according to the invention is provided for an at least partially muscle-powered two-wheeled vehicle, and in particular a bicycle and comprises at least one damping system, the damping system comprising at least one damping chamber partitioned in a first chamber and a second chamber by means of a movable piston and at least one low-speed throttle for the low-speed range and at least one high-speed throttle for the high-speed range. The high-speed throttle comprises at least one throttle valve biased to a closed position by means of a spring device. At least one effective flow cross-section for the high-speed throttle is adjustable.

The shock absorber according to the invention has many advantages. Changing the actually effective flow cross-section immediately influences the damper curve gradient so as to achieve effective adjustment and change of the characteristics in the high-speed range. The throttle valve shows a different characteristic with the damping characteristic being flatter or steeper depending on the changes. Basically though, the break point between the low-speed range and the high-speed range remains in the same spot.

In the present invention, the term “throttle valve” without any addition is always understood to mean a, or the, throttle valve of the high-speed throttle, unless a different purpose is explicitly indicated. Thus, in this application the term “throttle valve” by itself may consistently be replaced by the term “high-speed throttle valve”. Basically, at least one low-speed throttle valve may be comprised as well but then “low-speed” or the like will always be added for precision.

Preferably, at least three different effective flow cross-sections of the high-speed throttle can be set and adjusted. It is possible and preferred for the effective flow cross-section of the throttle valve of the high-speed throttle to be continuously adjustable. It is also possible for the effective flow cross-section to be adjustable in steps or discretely. In particular, the effective flow cross-section can be set in at least three, four or five or more positions of different sizes.

A combined stepped and continuous adjustability of the high-speed throttle is also possible and preferred. For example, (partial) ducts of the high-speed throttle may be closed partially or completely.

In a preferred embodiment, the high-speed throttle shows an adjustable flow cross-section in at least one flow duct. It is possible to provide several flow ducts and to change the flow cross-section of only one flow duct (or several flow ducts). It is not necessary to change the flow cross-sections of all the flow ducts. What is essential is adjustability of the entire available effective flow cross-section.

In advantageous configurations, the free flow cross-section is adjustable by way of at least one movable and/or adjustable adjusting unit. In simple configurations, it is possible to provide for example an axially movable lance element which may taper to a point toward its front end and which is inserted into a bore so that the effectively available cross-section is influenced by the (axial) position of the lance element. It is also possible for the adjusting unit to show at least one positioning body that is adjustable transverse to the flow duct. For example, it is possible to limit or reduce the free flow cross-section for example by a positioning body projecting laterally into the flow duct.

In other configurations, an adjustment of the positioning body concurrently or independently of adjusting the flow cross-section may also change the spring constant of a shim valve. This increases or decreases the flow resistance at the flow duct. Then, the flow duct itself does not need to always be directly changed by the positioning body.

Preferably, the free flow cross-section is at least partially configured at an adjustable flow valve comprising at least one flow duct. It is possible and preferred to provide a plurality of flow ducts and for the positioning body to at least partially cover at least one flow duct. In these configurations, in which at least one flow duct can be at least partially covered, the positioning body may be configured as a closing wall. It is possible to entirely or partially cover variable portions of the plurality of flow ducts in different positions.

In advantageous specific embodiments, a spring force of the spring device of the throttle valve is changeable. Then, it is possible to not only change the spring constant but the spring force applied can additionally be changed as well.

In all the configurations, it is possible for the spring force-biased throttle valve to be disposed in series or in parallel to the flow valve. Preferably, the throttle valve is configured as a shim valve and comprises at least one shim unit. A shim valve may comprise one shim or several shims or spring leafs. Preferably, the spring device acts on at least one shim unit of the shim valve.

It is particularly preferred for the spring device to be disposed off-center relative to the shim unit and for a spring constant to be variable by way of relative motion relative to the shim unit. Then, the spring device or part thereof may serve as a positioning body.

For example, linear guiding is possible where one component acting as a positioning body rests at least partially on the shim unit. The shim unit itself forms a spring which bends due to the streaming flow of the damping fluid. Now, if a positioning body that is (linearly or otherwise) movable rests on the shim unit, then adjusting the positioning body changes the system's spring constant.

A positioning body may, e.g. be configured as a positioning pin and may change a free flow cross-section of a flow duct, or alternately it may be configured e.g. as a closing wall, directly (indirectly or immediately) changing a free flow cross-section of a flow duct or it may influence e.g. a spring constant of a spring device through movement.

Particularly preferably, the spring device is disposed at the shim unit for pivoting about an eccentric axis. For example, a positioning body may be received off-center at the shim unit. The shim unit may, for example be formed by a round plate that is (centrally) fastened in the middle. The flow duct is located in an outer region. An angular alignment of a positioning body of the spring device thus changes the system's spring constant and the characteristic damper curve of the shock absorber can thus be adjusted and varied. A simple configuration provides for enlarging or reducing the supporting surface of the positioning body on the shim unit by way of controlled movement, thus intentionally influencing the spring constant.

In preferred specific embodiments, the throttle valve and/or the flow valve is/are preferably disposed inside a damper housing of the damping system. Alternately, it is also possible for the throttle valve and/or the flow valve to be disposed external of the damper housing of the damping system.

Preferably, the damping system includes a conventional oil as the damping fluid or another medium. Alternately, it is possible for the shock absorber or the damping system to contain a magnetorheological fluid and to be controlled by way of a magnetic field.

In all the configurations, it is preferred for the low-speed throttle to be adjustable. In advantageous configurations, preferably both the low-speed throttle and the high-speed throttle are adjustable. The low-speed throttle and the high-speed throttle may be provided for joint and simultaneous adjustment. Then, a shared actuator allows simultaneously adjusting or setting both throttles. Preferably, however, the low-speed throttle and the high-speed throttle are adjustable separately by way of separate actuators.

In all the configurations, it is preferred to provide low-speed throttles and high-speed throttles for the compression stage and the rebound stage.

On the whole, the invention allows adjusting the damping characteristics of a shock absorber from externally and/or internally. An adjustment in the high-speed range is enabled to be employed in the compression stage or the rebound stage. There is no or virtually no displacement of the break point at the transition from the low-speed range to the high-speed range.

The invention allows, for example in the direction of rebound considerably improved adjustment options over the existing prior art. In the past, conventional oil dampers could be optimally adjusted virtually only for a specific spring force curve. In another spring force curve, as it is for example required due to adapting the spring characteristics to a different rider's weight, the same rebound characteristics are not readily possible, adjustment notwithstanding. The damping in the high-speed range is too weak, and in the transition point region at the break, too strong.

In the direction of compression, the adjusting system known thus far causes adjustment of the “platform” effect. For example, if a rider wishes to increase the damping force for high or wide jumps, the additional damping force tends to show too little effect or results in an undesirably high stiffness in the transition range between the low-speed range and the high-speed range which shows adverse effects in different riding situations.

The invention enables adjusting the flow cross-section of the high-speed duct by means of a suitable adjustment member such as an adjusting unit and/or a positioning body.

The adjustment may take place internally or externally. The low-speed duct is not adjusted, only the high-speed duct is. It is possible though, to jointly adjust or throttle the ducts for low speed and high speed by means of the same adjusting unit.

It is possible for the damping fluid to first be throttled by the flow duct with the high-speed adjusting unit and thereafter to flow through the throttled spot in the low-speed duct. For example, an adjusting pin being the adjusting unit may influence a free flow cross-section of the high-speed flow duct. The result is a clearly increased influencing effect with maximum speeds without shifting the break point. The characteristic curve paths are parabolic since throttling takes place e.g. through a bore. Then the force does not increase linearly with the speed.

Changing the flow cross-section may also be achieved continuously or quasi continuously by closing several individual bores. When using a shim valve, the decisive flow cross-section is the gap beneath the shim which is achieved by an adjustable maximum deflecting amount of the shim or the shim unit.

Alternatively or additionally, the adjustment of the spring constant of the biasing device of the cover of the high-speed flow ducts may be possible.

In an alternate variant, a different shock absorber according to the invention is provided for an at least partially muscle-powered two-wheeled vehicle, and in particular a bicycle and comprises at least one damping system, the damping system comprising at least one damping chamber partitioned in a first chamber and a second chamber by means of a movable piston and at least one low-speed throttle for the low-speed range and at least one high-speed throttle for the high-speed range. The high-speed throttle comprises at least one throttle valve biased to a closed position by means of a spring device. A spring constant of the spring device of the throttle valve is changeable (and thus adjustable for the high-speed throttle).

This shock absorber has many advantages. It is a considerable advantage that, for example the spring constant of the spring device, which biases the throttle valve to the closed position, is adjustable. When the spring constant is changed, then the applied force also changes while the travel remains the same, or changing the spring constant will change the entire characteristic curve of the spring. The throttle valve shows a different characteristic with the damping characteristic curve being flatter or steeper depending on the changes to the spring constant. Basically though, the break point between the low-speed range and the high-speed range remains in the same spot. In specific embodiments, such a shock absorber may show a feature or several features as described above. In particular, it is also possible for such a shock absorber to have an effective flow cross-section of a throttle valve that is adjustable for the high-speed throttle.

On the whole, the invention offers clearly increased effects with maximum speeds while any displacement of the break point is only minimal. Opening the throttle valve enables a linear path of the force-speed characteristics.

For example, an eccentric member being the positioning body may change the local spring rate or spring constant of a shim valve. Stronger or weaker support of a shim unit surface effectively influences the spring rate.

### BRIEF DESCRIPTION OF THE DRAWINGS

Further advantages and features of the present invention can be taken from the exemplary embodiment which will be described below with reference to the enclosed figures.

The figures show in:

FIG. 1 a schematic illustration of a mountain bike;

FIG. 2 a schematic illustration of a shock absorber according to the invention;

FIG. 3 an adjustment option for adjusting a flow valve of the damping system according to FIG. 2;

FIG. 4 a top view of a throttle valve of the shock absorber according to FIG. 2;

FIG. 5 a sectional side view of the throttle valve according to FIG. 4; and

FIG. 6 a bottom view of an alternative throttle valve of the shock absorber according to FIG. 2;

FIG. 7 various characteristic curves.

### DETAILED DESCRIPTION

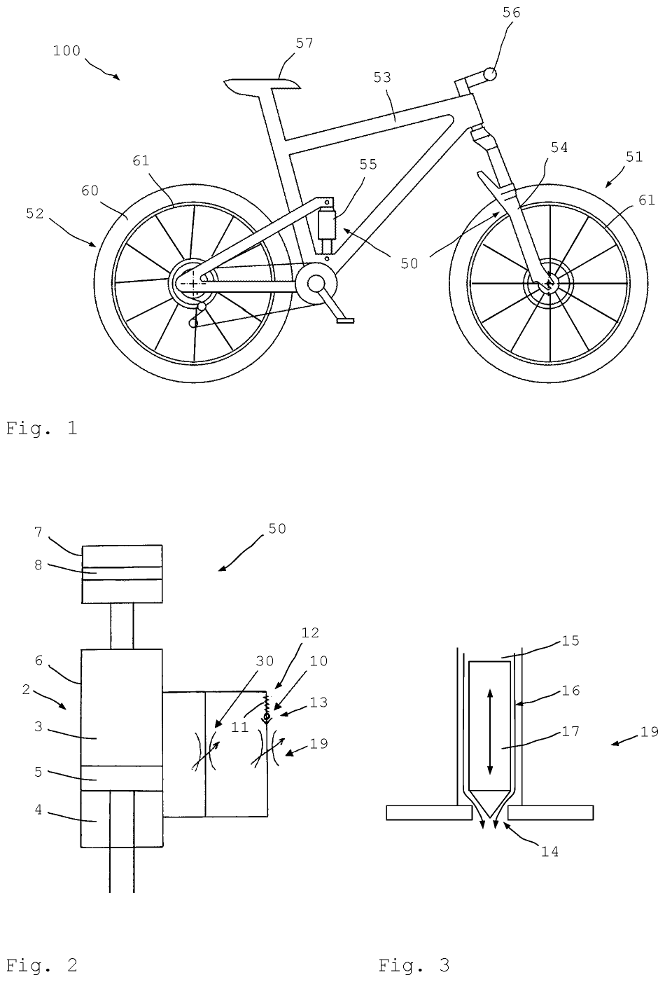

FIG. 1 illustrates a simplistic side view of a bicycle 100, which in this case is a mountain bike. The bicycle 100 is at least partially muscle-powered and may be provided with an electric auxiliary drive.

The mountain bike or bicycle 100 is provided with a front wheel 51 and a rear wheel 52, each having rims 61. Tires 60 are mounted to the rims. Furthermore, the bicycle 100 comprises a frame 53, a sprung front fork 54 and a rear wheel damper 55.

FIG. 2 is a simplistic view of a shock absorber 50 for the bicycle 100 in FIG. 1. The shock absorber 50 may be both a front wheel fork or a rear wheel damper.

Presently, the damping system 1 comprises a damper housing 6 in which a damping chamber 2 is disposed which is partitioned into a first chamber 3 and a second chamber 4 by way of a movable piston 5. To compensate for the entering volume of the piston rod, an equalizing chamber 7 having a dividing piston 8 is provided.

The first chamber 3 and the second chamber 4 are interconnected through flow ducts which are presently shown externally for better clarity. Alternately, it is possible to provide external and/or internal flow ducts. Basically, flow ducts may be accommodated internally in the piston as is shown e.g. in FIG. 6.

In the flow path, at least one low-speed throttle 30 and a high-speed throttle 10 are provided which are presently connected in parallel. Both the low-speed throttle 30 and the high-speed throttle 10 are adjustable.

The high-speed throttle 10 comprises for the same flow direction, two series-connected valves, a throttle valve 13 and a flow valve 19, both of which may be adjustable.

The flow valve 19 in FIG. 2 provides for adjusting the active flow cross-section to thereby vary the characteristic curve in the high-speed range as desired.

The throttle valve 13 is configured as a one-way valve, comprising a shim valve 20 having at least one shim unit 21. The throttle valve 13 is biased to the closed position by a spring device 11.

The closed position 12 is illustrated in FIG. 2. For example, a ball biased by a spring device 11 closes a flow duct. Other throttle valves such as shim valves etc. are likewise possible.

FIG. 3 shows a schematic design option for the flow valve 19 in FIG. 2. Here, a flow duct 15 is provided in which an adjusting unit 16 is disposed adjustable in the axial direction. The adjusting unit 16 is configured as somewhat like a lance element 17 showing a tapered, pointed front end element which partially projects into an opening of a wall so that it provides only part of the possible flow cross-section 14. As the adjusting unit 16 is inserted further into the opening, the remaining flow cross-section decreases, and vice versa. This configuration provides an effective way of adapting and adjusting the high-speed characteristic curve.

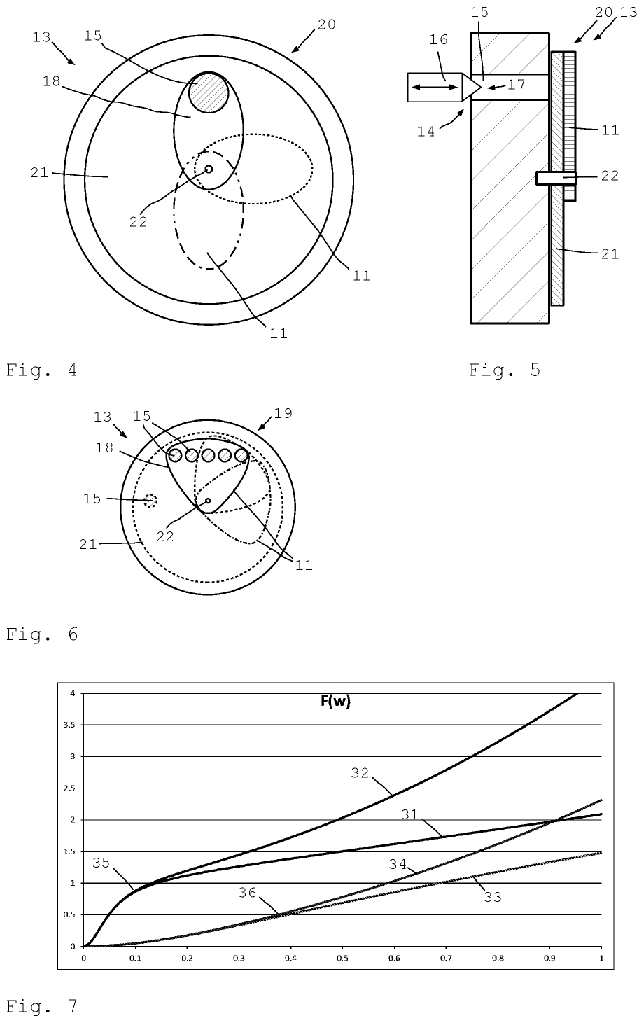

The FIGS. 4 and 5 show a schematic illustration of a throttle valve 13, FIG. 4 showing a top view and FIG. 5, a sectional side view.

This throttle valve 13 comprises a shim valve and has a shim unit 21. The shim unit 21 is a circular spring leaf and is centrally fixed to the axle 22. Therefore, the shim unit 21 also covers the hatched flow duct 15 so that any damping fluid from the bottom through the flow duct 15 can only escape upwardly as the spring force of the shim valve is overcome.

The figure shows that in the flow duct 15 an adjusting unit 16 or a lance element 17 is disposed to be adjustable in the axial direction. The lance element 17 projects into the opening and provides only part of the feasible flow cross-section 14. As the adjusting unit 16 is retracted further out of the opening, the remaining flow cross-section increases, and vice versa. This is where the flow cross-section and the spring rate or spring rigidity of the spring device 11 can be influenced.

FIGS. 4 and 5 show the shim valve 20 which is biased to the closed position 12 by a spring device 11. The spring device 11 is composed of the shim unit 21 and the leaf which is presently designated a spring device 11. The spring device 11 comprises at least one roughly oval leaf acting as a positioning body 18 which is/are rotatably accommodated off-center on the central axle 22. Adjusting the angle of rotation of the positioning body 18 may be done from the outside.

In the position shown in a solid line the positioning body 18 resting on the shim unit 21 virtually covers the entire flow duct 15. This considerably increases the spring rate or spring rigidity of the spring device 11 in the region of the flow duct. The characteristic curve turns considerably steeper.

A position rotated 90° is shown in a dotted line. In this position, the positioning body 18 no longer rests on the shim unit 21 immediately above the flow duct 15. However, the spring constant of the spring device 11 is entirely changed in the region of the flow duct 15. The weakest spring constant of the spring device 11 is set with the spring device 11 positioned in the dash-dotted line. In this spot, the spring constant of the shim unit is influenced or boosted the least. The characteristic curve is adjusted correspondingly flatter.

The decisive flow cross-section is the gap beneath the shim unit 21 which is adjusted by an adjustable maximum deflecting amount of the shim unit 21.

FIG. 5 shows a sectional, schematic side view of the illustration according to FIG. 4, the spring device 11 also being in the position in which the positioning body 18 resting on the shim unit 21 extends entirely across the flow duct 15. This achieves particularly high rigidity of the spring constant of the system of the spring device 11 consisting of the positioning body 18 and the shim valve 20 so that a particularly large force must be applied to bend the shim unit 21 wide enough open. Moreover, the effective flow cross-section is variable by way of axially adjusting the adjusting unit 16. It is possible to provide only one of the two adjusting functions.

FIG. 6 shows a schematic illustration of an alternative throttle valve 13 which may e.g. be realized in the piston.

Again, the throttle valve 13 may comprise a shim valve and have a shim unit 21 which is shown in a dashed line since it is attached e.g. to the bottom end of the piston. The shim unit 21 may be a circular spring leaf and be centrally fixed to the axle 22.

The illustrated shim unit 21 covers all the flow ducts 15 so that any damping fluid can escape downwardly into the plane of the drawing through the flow ducts 15 only as the spring force of the shim valve is overcome.

The shim valve 20 is biased to the closed position 12 by a spring device 11 not shown in detail. In simple cases, the spring device 11 may be formed by the spring force of a spring leaf or of a stack of spring leaves.

The throttle valve 13 has disposed at what is the top end of the flow ducts 15 a rotatable positioning body 18 which covers a variable portion of the flow ducts 15 depending on the angle of rotation. The positioning body 18 is rotatably accommodated off-center on the central axle 22. An adjustment of the angle of rotation of the positioning body 18 is again possible from the exterior.

In the position shown in a solid line in FIG. 6, the positioning body 18 closes the majority of the flow ducts 15. Preferably, the positioning body 18 does not completely close all of the flow ducts 15 so that the shim packet can still open up and damping does not increase undesirably high or even “infinitely” high. Therefore, it is possible to have at least one flow duct 15 uncovered at all times (the flow duct 15 shown in a dashed line).

In the dashed-line rotary position of the positioning body 18, the positioning body 18 only closes part of the flow ducts 15, and in the dash-dotted line rotary position none of the flow ducts 15 is covered by the positioning body 18. This allows effectiveness of changing the flow resistance and the passage resistance of the high-speed throttle.

FIG. 7 shows the result of the adjustment options of the invention by way of two basically different characteristic damper curves. The characteristic damper curves having the break point 35 show a relatively steep low-speed range, while the characteristic damper curves having the break point 36 show just a slight rise in the low-speed range.

The two break points or transitions 35 and 36 are shown with two variants 31 and 32, and 33 and 34 each. It can clearly be seen that different settings for the high-speed range virtually show no effect on the low-speed range and also virtually no effect on the transition or break point 35 or 36. The flatter progression of the characteristic damper curve 31 is only flatter from the break point 35. No displacement takes place.

The same applies to the two characteristic damper curves 33 and 34, which also show the same paths up to the break point 36.

On the whole, the invention provides an advantageous adjustment option for the high-speed range without showing undesirable effects on the low-speed range. Adjustment is possible by way of changing the flow passage and/or the spring characteristics, and in particular the spring constant.

While particular embodiments of the present shock absorber for a bicycle have been described herein, it will be appreciated by those skilled in the art that changes and modifications may be made thereto without departing from the invention in its broader aspects and as set forth in the following claims.

### LIST OF REFERENCE NUMERALS

| | |
|---|---|
| 1 | damping system |
| 2 | damping chamber |
| 3 | first chamber |
| 4 | second chamber |
| 5 | piston |
| 6 | damper housing |
| 7 | equalizing chamber |
| 8 | dividing piston |
| 10 | high-speed throttle |
| 11 | spring device |
| 12 | closed position |
| 13 | throttle valve |
| 14 | flow cross-section |
| 15 | flow duct |
| 16 | adjusting unit |
| 17 | lance component |
| 18 | positioning body |
| 19 | flow valve |
| 20 | shim valve |
| 21 | shim unit |
| 22 | axle, axis |
| 30 | low-speed throttle |
| 31 | curve |
| 32 | curve |
| 33 | curve |
| 34 | curve |
| 35 | transition |
| 36 | transition |
| 50 | shock absorber |
| 51 | front wheel |
| 52 | rear wheel |
| 53 | frame |
| 54 | fork |
| 55 | rear wheel damper |
| 56 | handlebar |
| 57 | saddle |
| 58 | battery |
| 59 | spoke |
| 60 | tire |
| 61 | rim |
| 100 | bicycle |

1. A shock absorber for an at least partially muscle-powered two-wheeled vehicle, and in particular a bicycle comprising: at least one damping system, the damping system comprising at least one damping chamber partitioned in a first chamber and a second chamber by means of a movable piston; and at least one low-speed throttle for the low-speed range; and at least one high-speed throttle for the high-speed range; the high-speed throttle comprising at least one throttle valve biased to a closed position by means of a spring device; and
at least one effective flow cross-section for the high-speed throttle is adjustable.

2. The shock absorber according to claim 1, wherein at least three different effective flow cross-sections of the high-speed throttle are adjustable.

3. The shock absorber according to claim 1, wherein the high-speed throttle shows an adjustable flow cross-section in at least one flow duct.

4. The shock absorber according to claim 1, wherein the free flow cross-section is adjustable by means of a movable adjusting unit.

5. The shock absorber according to claim 4, wherein the adjusting unit comprises an axially movable lance element and/or a positioning body adjustable transverse to the flow duct.

6. The shock absorber according to claim 1, wherein the free flow cross-section is at least partially configured at an adjustable flow valve comprising the at least one flow duct.

7. The shock absorber according to claim 5, wherein a plurality of flow ducts is provided, and at least one flow duct can be at least partially covered by the positioning body.

8. The shock absorber according to claim 1, wherein a spring constant of the spring device of the throttle valve is changeable, wherein a spring force of the spring device of the throttle valve is changeable, and wherein, in particular the spring force-loaded throttle valve is disposed in series or in parallel to the flow valve.

9. The shock absorber according to claim 1, wherein the throttle valve is configured as a shim valve and comprises at least one shim unit, and wherein the spring device acts on at least one shim unit of the shim valve.

10. The shock absorber according to claim 1, wherein the spring device is disposed off-center on a shim unit, or wherein the spring device is disposed at the shim unit pivotable around an eccentric axis, and wherein a spring constant is variable by way of relative motion relative to the shim unit.

11. The shock absorber according to claim 1, wherein the throttle valve and/or the flow valve is configured inside a damper housing of the damping system.

12. The shock absorber according to claim 1, wherein the throttle valve and/or the flow valve is disposed outside of a damper housing of the damping system.

13. The shock absorber according to claim 1, wherein the damping system comprises a magnetorheological fluid and is controlled by way of a magnetic field.

14. The shock absorber according to claim 1, wherein the low-speed throttle is adjustable, and wherein in particular the low-speed throttle is adjustable together with the high-speed throttle.

15. The shock absorber according to claim 1, wherein low-speed throttles and high-speed throttles are provided for the compression stage and the rebound stage.
